(19) United States
(12) Patent Application Publication
(10) Pub. No.: US 2002/0161828 A1
(43) Pub. Date: Oct. 31, 2002

(54) System and method for communicating with a device

(76) Inventors: Michael Edison, Alameda, CA (US); Wei Dong Yi, El Cerrito, CA (US); Erik Lawrence Peterson, Alamo, CA (US)

Correspondence Address: Oleg F. Kaplun, Fay Kaplun & Marcin, LLP, 100 Maiden Lane, 17th Floor, New York, NY, 10038, US

(21) Appl. No.: 09/845,573

(22) Filed: Apr. 30, 2001

(51) Int. Cl. G06F 15/16; G06F 9/44

(52) U.S. Cl. 709/203; 709/315

(57) ABSTRACT

A software package comprises an application broker export module exportable from a first device to a second device, the application broker export module including an instance opening sub-module for opening a first instance of an application broker for managing operation of applications exported from the first device to the second device and for opening a second instance of the application broker for managing operation of applications between the second device and a third device. A method of communicating comprises the steps of forwarding to a first device a first request from a second device, the first request including an application broker software package, initiating at the first device a first instance of an application broker from the application broker software package, wherein the first instance includes an object to process the first request and establishing a first connection between the first and second devices in response to the first request. A second request is received at the first device a second request from a third device and a second instance of the application broker is initiated at the first device. A second connection is then established between the first and third devices in response to the second request.

### BACKGROUND INFORMATION

In a computer network, information can be transferred between interconnected devices that are able to receive information and transmit information to other devices in the network. A network may include computer and non-computer devices capable of information transmission. Embedded devices are one example of non-computer devices that are capable of transmitting and receiving information via a network and web servers. Embedded devices may be programmable, and are generally used to control or monitor processes, machinery, environments, equipment, communications, etc.

Embedded devices have become popular because they are portable, can commnunicate over a network, and are capable of management via the Internet. The popularity of embedded devices has also been facilitated by the fact that web browsers and protocols promote wide data accessibility. Web browsers are a popular client interface to the Internet because of their low cost and wide availability. Protocols are also an important ingredient to wide accessibility because they are the rules that two or more network devices (e.g., computers or embedded devices) must follow to exchange information. One of the most common protocols, Transmission Control Protocol (“TCP”), is an Internet standard, connection-oriented, transport layer protocol that provides reliable data transmission. Another protocol, User Datagram Protocol (“UDP”), is a lightweight, connectionless TCP service suitable for managing data exchange between embedded devices because it is resource efficient. As a result of the wide accessibility of web browsers and protocols, web-based system management is less expensive and more flexible than most proprietary solutions.

Embedded devices generally consist of a proprietary, system specific code that is designed for the management of the system and not for web-based management. Hardware developers may not be able to anticipate all future software usage of the device and therefore may not be able to provide code translation from the system specific code to the web-based management software code. The embedded device system specific code may not be practical for management purposes, because it would need to be changed every time a new management function is implemented. An additional interface may be used to facilitate communication between an embedded device and a web browser. The embedded device may use a separate non-proprietary level of code for web-based management functions. That separate level of code may be controlled by the software designer, thereby leaving the system specific code intact, and freedom for the software designer to implement additional functions on the device.

Simple embedded programs collect data and format it into Hypertext Markup Language (“HTML”), which is the page description language used to format pages for viewing on the World Wide Web. As a result, the data is rendered as a web page, accessible by standard web browsers for remote management and control. Though the web commonly uses HTML, web-based management may require more functionality than HTML is capable of providing. Web-based management may require real-time access and control to device components such as switches and ports. JAVA® can provide such functionality. JAVA® is a computer programming language and computer software platform developed by Sun Microsystems that is open, object-oriented and contains executable programs. An execution utility, also known as the JAVA® Virtual Machine (“JVM”), may be built into web browsers to allow the execution of programs on virtually any operating system or hardware platform.

### SUMMARY OF THE INVENTION

The present invention is directed to a software package comprising an application broker export module exportable from a first device to a second device, the application broker export module including an instance opening sub-module for opening a first instance of an application broker for managing operation of applications exported from the first device to the second device and for opening a second instance of the application broker for managing operation of applications between the second device and a third device.

The present invention is further directed to a method of communicating comprising the steps of forwarding to a first device a first request from a second device, the first request including an application broker software package and initiating at the first device a first instance of an application broker from the application broker software package, wherein the first instance includes an object to process the first request and establishing a first connection between the first and second devices in response to the first request. A second request is received at the first device a second request from a third device and a second instance of the application broker is initiated at the first device. A second connection is then established between the first and third devices in response to the second request.

### BRIEF DESCRIPTION OF DRAWING

FIG. 1 shows an exemplary system allowing the transmission of data between system components according to the present invention;

FIG. 2 shows an exemplary embodiment of software components for an embedded device according to the present invention;

FIG. 3 shows a plurality of embedded devices logged into a single client according to the present invention;

FIG. 4 shows an example of multiple instances of an applet broker allowing for multiple connections to multiple devices according to the present invention;

FIG. 5 shows an exemplary message format for requests and responses between an applet broker and a protocol server according to the present invention;

FIG. 6 shows a method by which applets and applet brokers may be transferred from an embedded device to a client according to the present invention;

FIG. 7 shows an exemplary method for developing applet-based management for multiple network devices according to the present invention.

FIG. 8 shows an exemplary system for implementing applet-based management according to the present invention.

### DETAILED DESCRIPTION

The present invention may be further understood with reference to the following description of preferred exemplary embodiments and the related appended drawings, wherein like elements are provided with the same reference numerals. The preferred embodiment of the present invention will be described with reference to the JAVA programming language as an example of a programming language that may facilitate communication between various devices within a particular system. Therefore, JAVA programs such as applets and applet brokers will be used as examples of programs, which can manage remote communication. However, one skilled in the art will understand that the present invention may apply to other programming languages and applications producing the same result. Additionally, the preferred embodiment will be described with reference to a system having a client server and multiple embedded devices. The present invention is not limited to such a device arrangement. The present invention may be implemented on any system where multiple devices may be managed from some other single device on the system by providing brokers on each side of the device connection.

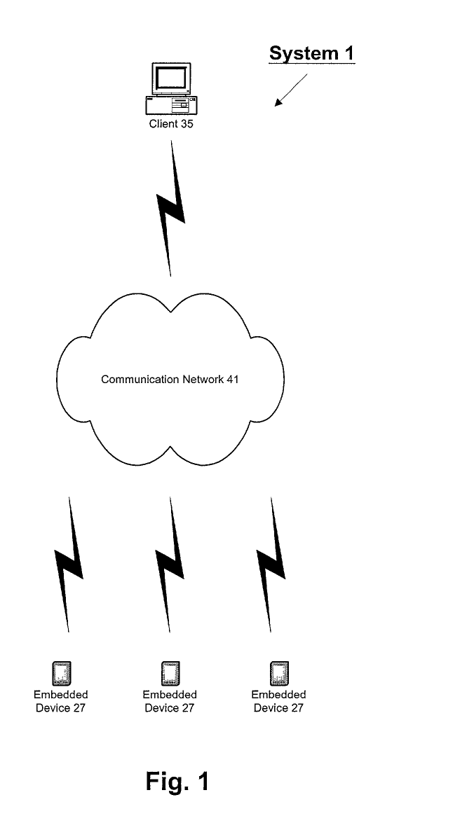

FIG. 1 depicts an exemplary embodiment of a system 1 allowing the transmission of data between a plurality of embedded devices 27 and a client 35 according to the present invention. The data may be transmitted between an embedded device 27 and a client 35 via a communications network 41 (e.g., Internet). Creating a connection between the embedded device 27 and the client 35, and using the JAVA Virtual Machine (“JVM”) software on the client 35 via the connection is an alternative to embedding JAVA on the embedded device 27. This method provides a mechanism for web-based management of the embedded device, where the burden is shifted to the resources of the client software rather than the embedded device. The client 35 may operate a web browser such as Microsoft's Internet Explorer, Netscape Navigator, or other third-party web browsing software. The web browser software operated by client 35 will manage the data that is transmitted to the client 35 from an embedded device 27. The data transferred from the embedded device 27 may be, for example, HTML code or applets. Formatting tags are embedded in a text file. These formatting tags are interpreted when the document is viewed in the web browser. These formatting tags may also include programs that may be executable and perform certain functions. One such program is an applet, which may be written in the JAVA language and may be distributed as an attachment in an HTML document. The applet code may then be transferred to the client 35, and executed by the browser's JVM on client 35.

An applet broker which is a program that can manage all communication between the embedded device 27 and the client 35, may also be included in the system 1. Applet brokers may have multitasking and multi-session capabilities, which will be described in greater detail below. The applet broker loads into the client 35 web browser via the communications network 41. The applet broker may reside on the embedded device 27 as inactive, and be transferred to the web browser by a network connection (e.g., Internet) when applets are transferred from the embedded device 27 to the client 35. The basic functions of the applet broker include retrieving data from a network device, such as embedded device 27, at given intervals or randomly, sending data to an embedded device 27, and receiving unsolicited data from embedded device 27.

JAVA applets may run within a “sandbox,” which separates downloaded applets from the client 35 to prevent malicious applets from destroying or altering information contained on client 35. Most web browsers are equipped to separate applets into sandboxes thereby preventing applets from performing destructive actions. For example, a web browser may prevent applets from reading and writing to a storage device on client 35 (e.g., hard drive), accessing specific system information from client 35, sending TCP packets to machines other than the embedded device 27 from which the applet was sent, opening UDP sockets, controlling thread groups, and launching applications. However, sandbox security does not allow an applet broker to use a UDP connection to the embedded device 27 for the purpose of minimizing resources, or to control the necessary broker threads. As a result, the applet broker must run outside of the sandbox. In order for an applet broker to run outside of the sandbox, it must be signed by a web browser.

Several signing methods exist. Netscape Navigator signs individually actual JAVA class files that need restricted access under the method of Object Signing. On the other hand, Microsoft Internet Explorer signs a cabinet file in which the JAVA class files are stored for permitting access beyond restrictions. This method of signing is known as Authenticode. A third party may also sign, permitting restricted access. For example, if the third party software vendor signature is used the first time the applet broker is loaded, a web browser such as Netscape Navigator or Internet Explorer will present the user with a dialog box informing the user that a third party software vendor is requesting restricted access. If the user denies the access, the applet broker will not function.

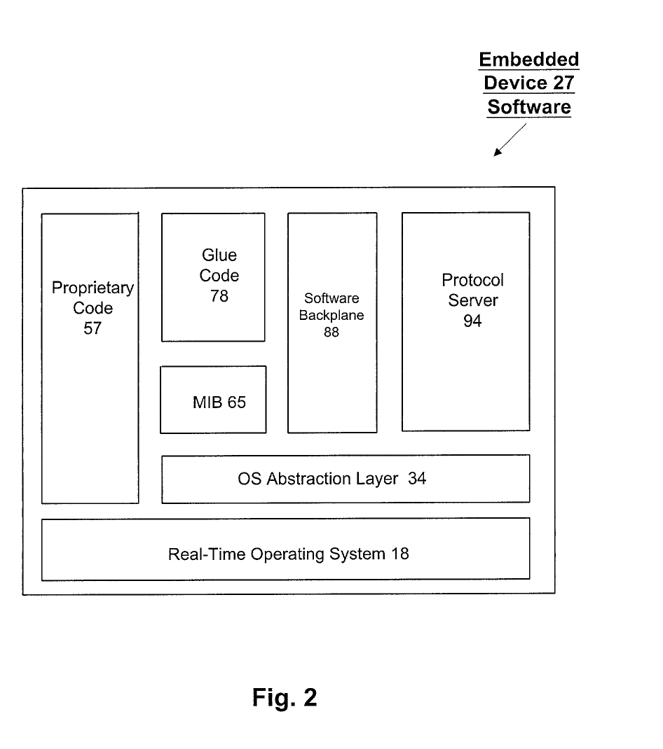

FIG. 2 shows an exemplary embodiment of software components of an embedded device 27 according to the present invention. Those skilled in the art will understand that FIG. 2 is limited to software components for the embedded device 27 which also may contain a variety of hardware components such as a microprocessor (e.g., with 32-bit or 64-bit capable architecture), a storage device (e.g., random access memory, flash memory), various ports or other devices capable of remotely modulating or demodulating signals across the communications network 41, etc. Referring back to FIG. 2, system specific code 57 allows the manufacturer of the embedded device 27 to exclusively integrate code into the basic operation of the embedded device 27. The system specific code 57 forms the basis of an operating system or programming language. The glue code 78 is a series of read and write access methods to the data found in the system specific code 57. The glue code 78 may be considered a pathway for accessing the data in the system specific code 57.

Embedded device 27 may also contain software backplane 88 which may be a database collection of mappings that reside on the embedded device 27 and provide access to the system specific code 57. These mappings are linked to data that resides on the embedded device 27 and are associated with properties, such as access functions. For example, if an embedded device 27 has data for the name of a given user, the software backplane 88 would contain an entry for “name of user” and read/write function pointers for read/write access to the name data. This allows for getting and configuring data on the embedded device 27. The software backplane 88 is also one of the layers that separate the system specific code 57 from the management code allowing software backplane 88 to act as a unified method of access for security and management of the embedded device 27.

An OS abstraction layer 34 provides methods for the other application software on the embedded device 27 (e.g., protocol server 94) to make system calls to a Real Time Operating System (“RTOS”) 18. The RTOS 18 provides the embedded device 27 with low-level services such as memory allocation, network services, and semaphores. RTOS vendors may include various features to address needs in specific markets. An optimal RTOS 18 may include support for a wide range of software and hardware platforms, support for multi-level interrupt process-level priorities, support for multi-threaded operations, and support for the ANSI C programming language. An examples of an RTOS 18 is VxWorks®, sold by Wind River Systems of Alameda, Calif. The OS abstraction layer may also provide connection server services to monitor connections (e.g., TCP connections, UDP connections) necessary to handle incoming request messages.

A protocol server 94 facilitates exchange of data in the form of HTML Applets between the embedded device 27 and the client browser 35. An exemplary embodiment of a protocol server 94 may be composed of a fully functional Hypertext Transfer Protocol (“HTTP”) server, a Common Gateway Interface (“CGI”) handler for handling data exchanges between the server and ancillary programs, and a Simple Mail Transfer Protocol (“SMTP”) capability for sending data out of the protocol server 94.

Those skilled in the art will understand that each of these software components may be an independent software program component or may be combined with other components to form a software program having multiple features. For example, the software backplane 88, the OS abstraction layer 34 and the protocol server 94 may be combined to form applet distribution software capable of exchanging HTML and applets between the embedded device 27 and the client 35. An example of applet distribution software is the RapidControl for Applets sold by Wind River Systems of Alameda, Calif. Each of these components may be written in any of a variety of programming languages, for example, ANSI C source code.

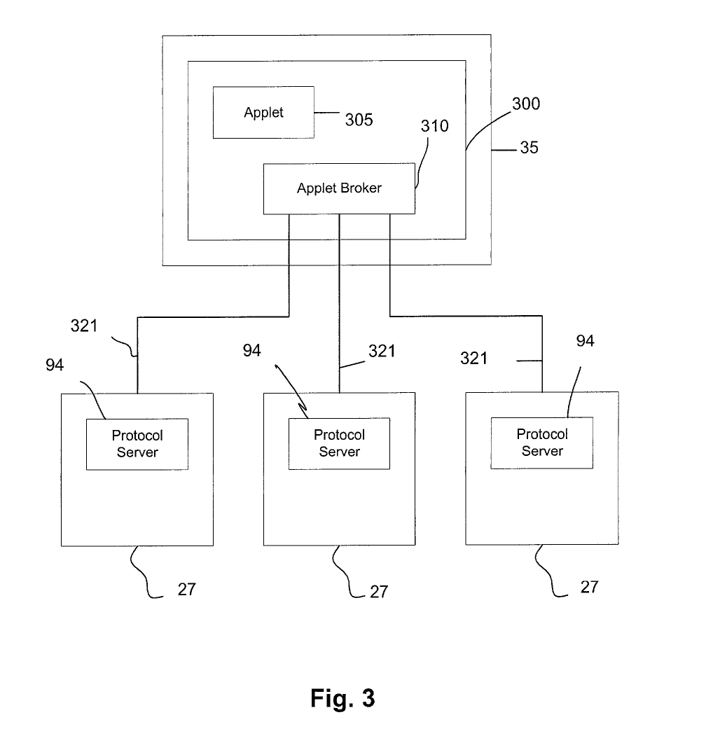

FIG. 3 shows a plurality of embedded devices 27 logged into a single client 35 which has a web browser 300. An applet 305 and an applet broker 310 have been loaded into the web browser 300. The process for loading the applet 305 and the applet broker 310 into the web browser 300 will be described in greater detail below. Each embedded device 27 also includes a protocol server 94 which is capable of communicating with applet broker 310 in client 35 or with the protocol servers 320 in any of the other embedded devices 27. The protocol server 94 is an executable program that may be written, for example, in the ANSI C programming language (i.e., an ANSI C broker). The protocol server 94 is a request/response protocol supporting device side events. Device side events may include, for example, login requests, get requests, set requests, dump requests, develop information requests and logout requests. The protocol server 94 may include a communications driver interface that handles the supported communications protocol of the device (e.g. UDP, TCP), a separate interface that receives and interprets data, executes code, and returns data to the communications driver for disbursement. An information database may also be included within the protocol server 94 for storing information that is queried.

In FIG. 3, the connections 321 are shown between the applet broker 310 of client 35 and the protocol servers 320 of the embedded devices 27. Those skilled in the art will understand that such connections 321 may be accomplished through communications network 41 as shown in FIG. 1 via an appropriate communications protocol (e.g., UDP, TCP). The connections 321 are established by connecting a first embedded device 27 either directly or remotely to a client 35 via the communications network 41. The protocol server 94 attached to the embedded device 27 sends a request to a client 35. The applet broker 310 on the client 35 listens for the request. Once the applet broker 310 receives the request, it validates the request, creates a process handler to satisfy the request of the first protocol server 94, and then goes back to listening for additional requests. This procedure for connecting the protocol servers 320 of the embedded devices 27 may be repeated with the various embedded devices 27 simultaneously. Similarly, requests from applet broker 310 are responded to by protocol servers 320 on the device side.

When a connection to the applet broker 310 is established, the embedded device 27 may log into the client 35 with an access code. This log in is accomplished via the protocol servers 320 which may also be used to log out of the applet broker 310. The embedded device 27 sends the access code to the applet broker 310 which verifies the access code and stores information about the connection with the embedded device 27. The information about the connection may be stored in various manners including, for example, table form and/or database form, for each of the connections 321 which the applet broker 310 is managing. Information that the broker 310 may store includes individual timeout information for the connection 321 to the particular embedded device 27. Timeout information is the discontinuance of a process if an expected event does not occur within a predefined amount of time. Other information stored by the applet broker 310 may include event information for each of the connections 321 (e.g., get requests, set requests, etc.).

Multiple connections 321 may be maintained because the applet broker 310 of the client 35 may maintain multiple instances of itself to manage the connections 321. These multiple instances will be described in greater detail below. These multiple connections 321 are sometimes referred to as multi-sessions maintained by the applet broker 310. The protocol servers 320 of the embedded devices 27 also include additional resources allowing the maintenance of multiple connections 321. The functionality added by the protocol servers 320 (e.g., communications driver interface, information database, etc.) allows requests and responses from embedded devices 27 to the applet broker 310 of the client 35 to be identified as associated with a particular device. Thus, the applet broker 310 may maintain multiple connections 321 instead of being dedicated to an individual connection for a single device. As the protocol servers 320 log in and out of the client 35, the applet broker 310 may maintain a list of the device connections including information as described above. The applet broker 310 and the protocol servers 320 also allow the transfer of files and the generation of events to occur for multiple connections 321. Those of skill in the art will understand that a single protocol server 94 may also maintain multiple connections to multiple applet brokers 310. The functionality described above that is included in the protocol server 94 allows it to transmit messages to and receive messages from multiple applet brokers.

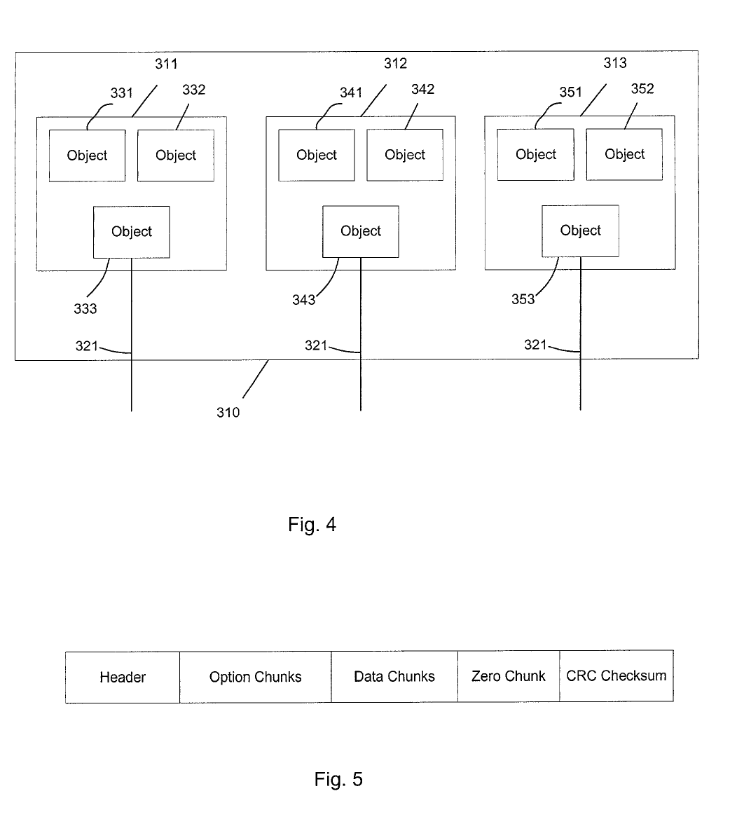

FIG. 4 shows an example of multiple instances 311-313 of the applet broker 310 allowing for multiple connections 321 to multiple devices. As described above, the applet broker 310 may be connected to multiple devices at any one time. In the example of FIG. 3, the applet broker 310 is connected to three devices 27. In order for the three connections to be maintained, three instances 311-313 of the applet broker 310 must be maintained. Each instance of the applet broker 310 signals a connection 321 to a device. However, there may be multiple threads in each of the connections 321 to satisfy data transfer requirements between the applet broker 310 and any of the devices to which it is connected. Each instance 311-313 of the applet broker 310 contains objects, for example, the instance 311 has objects 331-333, the instance 312 has objects 341-343 and the instance 313 has objects 351-353. In this example, it may be considered that objects 331, 341 and 351 are packet parser objects, objects 332, 342 and 352 are packet builder objects and objects 333, 343 and 353 are communications objects. Those skilled in the art will understand that each instance 311-313 of the applet broker 310 may contain other and/or different types of objects and the objects described here are only exemplary. The packet builder objects 332, 342 and 352 may be used to build requests and/or responses to be transmitted by the applet broker 310 to its connected device. The packet parser objects 331, 341 and 351 may be used to parse requests and/or responses received from the connected device. The communications objects 333, 343 and 353 may be used to establish a connection 321 to the connected device, transmit requests/responses to the connected device and route received requests/responses to the correct object within the applet broker 310.

In the example of FIG. 4, each object may be dynamically allocated and managed by the applet broker 310 meaning that each instance 311-313 of the applet broker 310 is dynamically manageable. As connections 321 are broken (e.g., a device logs out) the applet broker 310 may delete instances. Similarly, as new device connections 321 are added (e.g., a device logs in) new instances of the applet broker 310 may be added. In order to manage the dynamic objects, the applet broker 310 maintains a listing (e.g., an array, database, etc.) of each instance of an object and its corresponding connection information. For example, the applet broker 310 may maintain a listing showing that objects 331-333 are in instance 311 of the applet broker 310. The listing may further include information about the corresponding connection 321 (e.g., the device to which it is connected.). As described above, the applet broker 310 may also maintain other information about the connection, for example, timeout information and event information.

Maintaining this information about each connection and its corresponding objects, the applet broker 310 may discern between requests/responses from different devices. It may also determine when a new instance of the applet broker 310 is required because it has received, for example, a login request from a device which it does not recognize as related to a current instance 311-313. Similarly, when the applet broker 310 receives a logout request or a timeout occurs, the applet broker 310 may delete the instance 311-313 corresponding to the device which is logging out or timing out. In this manner, the applet broker 310 may dynamically manage multiple instances 311-313 of itself

FIG. 5 shows an exemplary message format 400 for requests and responses between the applet broker 310 and the protocol server 94. Those of skill in the art will understand that exemplary message format 400 is only one possible manner of formatting the requests and responses between the applet broker 310 and the protocol server 94. Numerous other message formats may also serve in the transmission of requests and responses. Exemplary message format 400 contains a header 410, option chunks 420, data chunks 430, a zero chunk 440 and a CRC checksum 450. Each of these fields will be described in greater detail. The CRC (cyclic redundancy check) checksum 450 is a number inserted in the message format 400 to determine whether the request/response has changed since it was transmitted (i.e., to determine if any information has been dropped from the message). The zero chunk 440 is inserted to signal the end of the message. Data chunks 430 contain data such as integers and strings—for example, HTML text. Option chunks 420 define modifying parameters such as a context string which may be used to provide context for markup operations that may be defined in the message. Other examples of option chunks 420 may be an error string to be used in error handling, response codes which signal success or error code for an associated request, a range start or range end signal which represents the starting index or ending index, respectively, of an iteration to be applied to all markup operations defined in the message, etc.

The header field 410 may contain a flag to signal the beginning of the message and a connection ID which identifies an applet broker (e.g., applet broker 310) to the device or vice versa since each applet broker may communicate with multiple devices and each device may communicate with multiple applet brokers. The header field 410 may also contain a message ID which is generated by the originator of a request. The responder may then use the same message ID in responding to the request. For example, a login request may have a message ID of 0 and the response to the login request will also contain a message ID of 0. All subsequent requests may be numbered sequentially. The header field 410 may also identify the type of message (e.g., login request, login response, get request, get response, etc.) and the length of the entire message. Those skilled in the art will understand that the preceding information is only exemplary and that there may other types of information that may be stored in a message depending on the particular application.

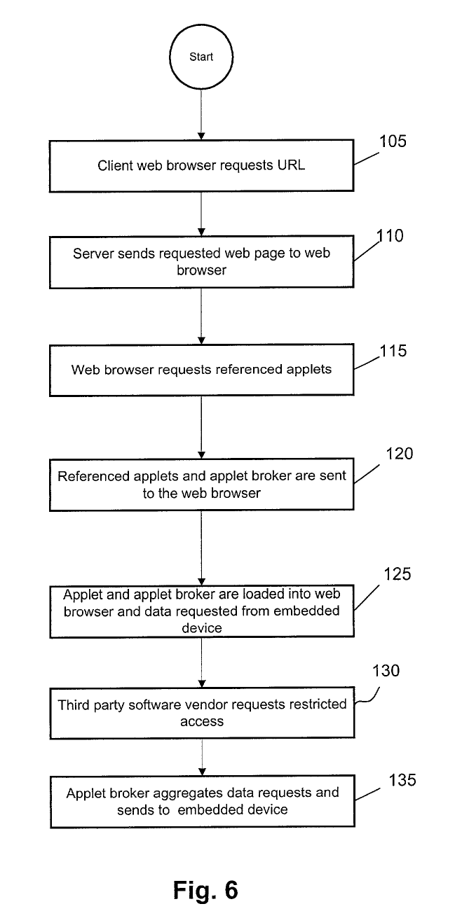

FIG. 6 shows an exemplary method by which applet 305 and applet broker 310 may be transferred from the embedded device 27 to the client 35, and then executed by the client 35 to perform various monitoring and managerial functions for the embedded device 27. Those skilled in the art will understand that the exemplary method described below includes the use of a web browser. However, the communication between the applet broker and the protocol server may be independent of the web browser once the applet broker has been transferred to the client, even though the web browser was used to transfer the applet broker (e.g., the communication between the applet broker and the protocol server may be on a different port than the port used by the web browser). In Step 105, a web browser 300 running on client 35 requests a uniform resource locator (“URL”), the global address of a document, file, or other resource on the World Wide Web. The URL may specify a web page located on the embedded device 27 which may store web pages and referenced applets in non-volatile memory or other storage system that preserves data after the embedded device 27 has been turned off.

Generally, a web page is comprised of HTML code and is sometimes referred to as an HTML User Interface page. However, those skilled in the art will understand that it may be possible to construct a web page using software code other than HTML. A web browser, such as Internet Explorer, is simply a software client application that converts the software code contained in the web page (e.g., HTML code) into information that can be understood by a remote user by displaying the web page on the monitor of the remote user. The content of the web page may include information on monitoring and/or managing embedded device 27 and may also reference one or more applets (e.g., applet 305). There may be two types of applets, presentation applets and data applets. A presentation applet is a program that provides for visual components, such as graphs and charts, which make up the real-time user interface. A data applet is a program that allows a user to do basic analysis of variables in a data set. A data set may contain a number of variables on a number of observations, which may be chosen manually or provided automatically.

When the web page is found via the communications network 41 (e.g., Internet), it may be fetched by client 35 via HTTP protocol. In Step 110, a web server (e.g., an HTTP compliant server) on the embedded device 27 examines the URL request from the web browser, and then sends the requested web page back to the web browser running on client 35. When the web browser retrieves and analyzes the web page with, for example, HTML tags, the client 35 may then request referenced applets (e.g., applet 305) within the web page from the embedded device 27. (Step 115). The referenced applets may be specified in the web page by, for example, HTML tags.

In Step 120, referenced applets (e.g., applet 305) are then sent from the embedded device 27 to the client 35 via, for example, HTTP protocol. Such applets may provide, for example, real-time monitoring and control for the device. The requested applets may be accompanied by an applet broker 310. Once the applet broker 310 has been transferred to the web browser 300, it remains within the browser until the web browser is closed. The applet broker 310 is not visually present, but remains active within the client 35 web browser 300 until termination of the web browser 300. All applets may use the same multitasking applet broker 310 once the applet broker 310 has been loaded into the web browser 300. When the browser executes the applets (e.g., applet 305), the applet broker 310, running within the browser 300, can manage communication efficiently between the web browser 300 and the embedded device 27. Such communication occurs by a real-time exchange of data with the embedded device 27 via, for example, UDP protocol. In order for this real time exchange to occur, the applet broker 310 must be connected to both the applets and the embedded device 27. The applet broker 310 may connect to a running applet (e.g., applet 305) via the web browser 300, since the applet broker 310 runs within that same web browser 300. The applet broker 310 may gain a network connection to the embedded device 27 via a login procedure that is carried out by protocol servers 320 as described above. The protocol server 94 facilitates the login that allows the applet broker 310 to carry the list of connected devices. Code is transferred between the protocol server 94 and the applet broker 310 via, for example, UDP or TCP. Therefore, the applet broker 310 may be connected simultaneously to a plurality of network devices such as one or more embedded devices 27.

When a requested applet (e.g., applet 305) has reached client 35 along with an accompanied applet broker 310, and both have been loaded into the web browser 300, the running applet may request data from the embedded device 27. (Step 125). A third party signature may be used to permit the applet broker 310 to gain restricted access so that it can operate and begin managing an exchange of requested data between the embedded device 27 and the client 35. In Step 130, the web browser 300 may present the user with a dialog box informing the user that a third party software vendor is requesting restricted access. The user may accept or decline the restricted access. The user may decline the restricted access if there is a suspicion that the applet broker 310 may contain malicious code that may damage client 35. If the user accepts the restricted access, the applet broker 310 is then functional. In Step 135, the applet broker 310 aggregates all the data requests, and sends the aggregate request to the embedded device 27 by, for example, UDP. This aggregation of requests allows the applet broker 310 to manage the communications on a global level in order to minimize the amount of overhead that is necessary to transfer data between devices.

Those skilled in the art will understand that the present invention may operate independently of the web server on embedded devices 27 and web browser of the client. For example, referring to FIG. 3, applet 305 or other applications and applet broker 310 or other similar broker may be independently loaded onto client 35. The user of client 35 may start applet 305 including applet broker 310. The developer of applet 305 may include information as to the devices with which applet broker 310 should establish communication. For example, applet 305 may contain information as to the IP addresses of each of embedded devices 27 and the port number with which applet broker 310 should establish communication. Applet broker 310 may then establish communication with protocol servers 94 in each of embedded devices 27 without any interaction with the web server on embedded devices 27. Additionally, because applet broker 310 establishes connection 321 independent of the connection of web browser 300, applet 305 and applet broker 310 may operate while web browser 300 is closed or inactive.

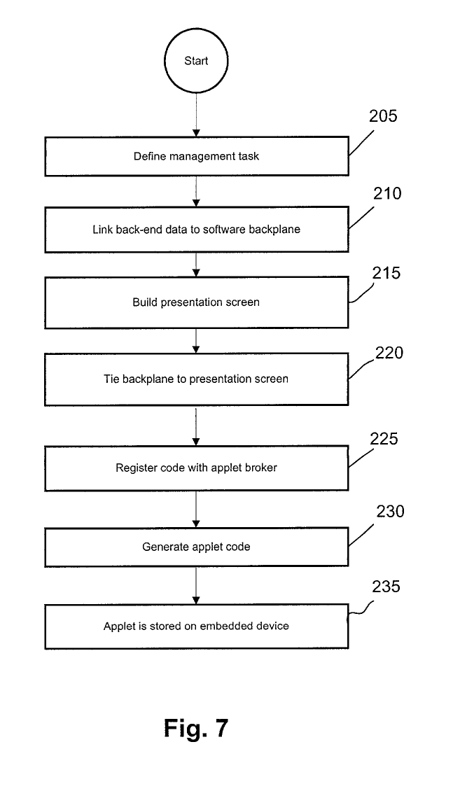

FIG. 7 shows an exemplary method for developing applet-based management for multiple network devices. This method explains how an applet broker 310 knows which applet is requesting data, what data is required, and when that data is requested. According to the method, developers may generate dynamic presentation and data manipulation applets, and conFig. an applet broker 310. In Step 205, the developer defines a management task. An exemplary management task may be the display, in real time, of the number of packets sent through an interface as opposed to the number of dropped packets. A packet may be dropped for many reasons such as the client 35 not being able to keep up with the rate at which data packets are being sent from the embedded device 27. Therefore, it may be important to monitor this type of device function for preventing loss of network connectivity.

Referring to FIG. 2, the software backplane 88 is a database of entries wherein an entry is a mapping between a data reference and relevant function pointers to particular access routines. Access routines are access methods that are part of the glue code 78. In Step 210, the relevant data from the system specific code 57 (e.g., data relating to sent packets and dropped packets) must be linked to the software backplane 88 through certain entries. Exemplary entries for the purpose of monitoring packets may be referred to as ifInPackets and ifDroppedPackets. The designer may specify the routines to be used to retrieve data. These routines may be called GetIfInPackets and GetIfDroppedPackets. The developer may generate an ANSI C source file which, when compiled and linked in with the rest of the system specific code 57, causes the two software backplane 88 entries to be generated on the embedded device 27. These two software backplane 88 entries provide a window to the data relevant to data packets either being dropped or arriving at some interface.

In designing an applet, the developer may use various JAVA beans such as charts on the design canvas in order to build the presentation screen. (Step 215). A JAVA bean is a supplementary Application Programming Interface (“API”) that will link JAVA executables to other external resources. The primary purpose of JAVA beans is to enable the visual construction of applications. The developer may have pre-conFig.d commercial JAVA bean packages available and may also create and/or load new beans to be registered either because vendors would like to buy independent JAVA bean packages or make their own JAVA beans. An exemplary embodiment of a JAVA bean in the present situation would be a Pie Chart Bean. In building the presentation screen in Step 215, the developer may conFig. certain properties of the Pie Chart Bean through a Property Editor, such as changing the color of the Pie Chart background.

In Step 220, the developer ties the software backplane 88 entries (e.g., ifInPackets and ifDroppedPackets) onto the presentation screen (e.g., the JAVA beans). The entries in the software backplane 88 are the mappings linked to data that resides on the embedded device 27 and are associated with properties, such as access functions. In step 220, a JAVA source code file is generated dynamically. The source code ties the backplane entries to the selected property or method of the given JAVA bean. Therefore, the data that resides within the system specific code 57 of the embedded device 27 is linked, through a mapping element located within the software backplane 88, to a selected property or method of a JAVA bean. In Step 225, the resulting source code file can then be registered with the applet broker 310 and the applet code (e.g., the code for a Pie Chart applet) may be generated in Step 230. The applet code is dynamically generated with support for JAVA beans and backplane elements on the presentation screen. In Step 235, the applet is stored on the embedded device 27, unless the applet has been transferred to client 35, and loaded into a web browser when the appropriate HTML page is loaded.

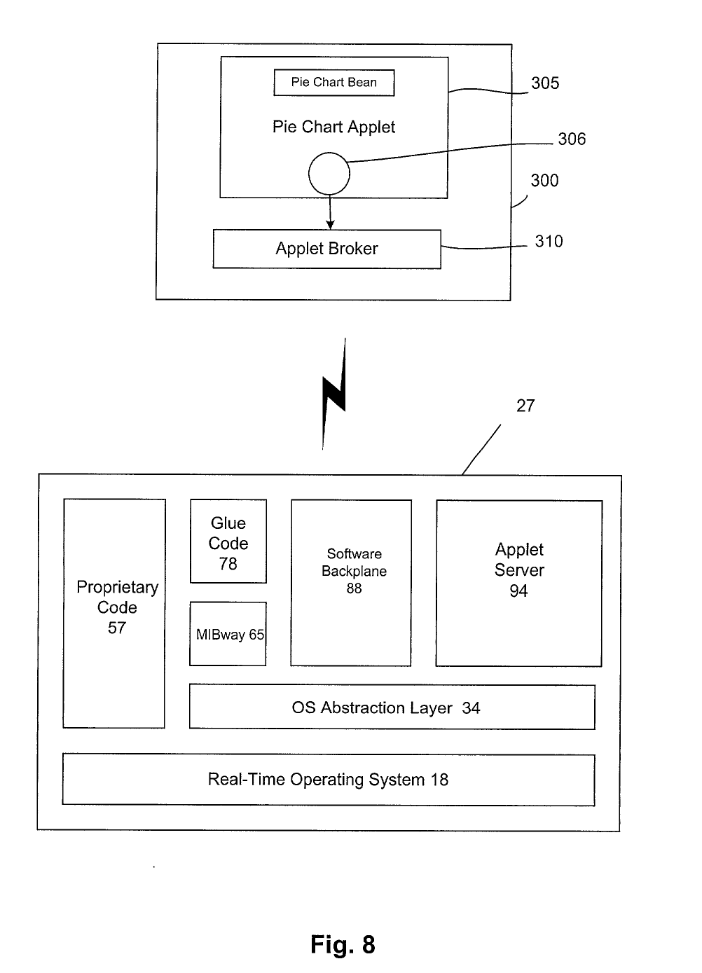

FIG. 8 shows an exemplary system for implementing applet-based management. An applet broker 310 that has been registered to recognize a dynamically generated hookup file 306 attached to an applet 305, will accompany an applet transfer to the client 35, upon the loading of a web page that references the applet 305. The applet broker 310 contains an engine that can collect data requests by contact with the hookup class file 306 associated with the applet 305. This engine can then aggregate the data requests, and bundle the requests into a single packet (e.g., a UDP packet). Finally, the engine can transfer the aggregate of data requests by multiplex and demultiplex communication between the applet 305 and the embedded device 27. In this example, the applet 305 is a pie chart applet that is related to the dropped packet example started above. Multiplexing involves transmitting two or more signals over a single channel. Demultiplexing involves separating two or more signals previously combined by compatible multiplexing equipment.

The packet is received by the embedded device 27, and the data request is broken down and analyzed by the protocol server 94. The protocol server 94 may then access the entries in the software backplane 88 corresponding to, for example, ifInPackets and ifDroppedPackets of the dropped packet example. Once the entries have been returned, the protocol server 94 may access the data from the system specific code 57 since the protocol server 94 now has pointers to the GetIfInPackets and GetIfDroppedPackets routines. After the data has been retrieved, it is again bundled up in a packet, and sent back to the web browser 300. The applet broker 310 receives the data and demultiplexes it to the hookup classes 306, which pass the data to the Pie Chart applet 305. The Pie Chart applet 305 receives the data and processes it to display a dynamic chart showing the percentages of dropped packets and packets passing through an interface.

In the preceding specification, the present invention has been described with reference to specific exemplary embodiments thereof. It will, however, be evident that various modifications and changes may be made thereunto without departing from the broadest spirit and scope of the present invention as set forth in the claims that follow. The specification and drawings are accordingly to be regarded in an illustrative rather than restrictive sense.

What is claimed is:

1. A method of communicating, comprising the steps of:
forwarding to a first device a first request from a second device, the first request including an application broker software package;
initiating at the first device a first instance of an application broker from the application broker software package, wherein the first instance includes an object to process the first request;
establishing a first connection between the first and second devices in response to the first request;
receiving at the first device a second request from a third device;
initiating from the application software package a second instance of the application broker at the first device, wherein the second instance includes an object to process the second request; and
establishing a second connection between the first and third devices in response to the second request.

2. The method according to claim 1, wherein the first instance of the application broker includes an applet broker.

3. The method according to claim 1, wherein the second device is an embedded device and wherein the application broker facilitates one of monitoring and manipulation of the second device from the first device.

4. The method according to claim 1, wherein the first instance of the application broker reads information data included in data forwarded from the second device to the first device to determine that the data was forwarded from the second device.

5. The method according to claim 1, wherein the application broker export module opens a first communication thread between the first and second devices and a second communication thread between the second and third devices.

6. The method according to claim 5, wherein the first communication thread utilizes a communication path different from that used to export the application broker export module from the second device to the first device.

7. The method according to claim 1, wherein the first instance and the second instance exist simultaneously at the first device

8. A software package comprising an application broker export module exportable from a first device to a second device, the application broker export module including an instance opening sub-module for opening a first instance of an application broker for managing operation of applications exported from the first device to the second device and for opening a second instance of the application broker for managing operation of applications between the second device and a third device.

9. The software package according to claim 8, wherein the first instance of the application broker includes a first plurality of objects for generating messages for transmission to the first device and the second instance of the application broker includes a second plurality of objects for generating messages for transmission to the third device.

10. The software package according to claim 8, wherein the first and second instances of the application broker operate substantially simultaneously.

11. The software package according to claim 8, wherein the application broker includes an applet broker.

12. The software package according to claim 11, wherein the first device is an embedded device and wherein the application broker facilitates one of monitoring and manipulation of the first device from the second device.

13. The software package according to claim 8, wherein the first instance of the application broker reads information data included in data forwarded from the first device to the second device to determine that the data was forwarded from the first device.

14. The software package according to claim 8, wherein the application broker export module includes a thread opening sub-module for opening a first communication thread between the first and second devices and a second communication thread between the second device and the third device.

15. The software package according to claim 14, wherein the first communication thread utilizes a communication path different from that used to export the application broker export module from the first device to the second device.

16. The software package according to claim 11, wherein the applet broker operates in conjunction with web browser software running on the second device to interact with a web page hosted by the first device.

17. The software package according to claim 9, wherein the first plurality of objects includes a packet builder object to build one of requests and responses to be transmitted from the first instance of the application broker to the first device.

18. The software package according to claim 9, wherein the first plurality of objects includes a packet parser object to parse one of requests and responses received from the first device.

19. The software package according to claim 9, wherein the first plurality of objects includes a communications object to establish a connection between the second device and the first device and to transmit one of requests and responses between the first and second devices.

20. The software package according to claim 19, wherein the communications object routes one of requests and responses to a corresponding one of the first plurality of objects within the application broker.
